(19) United States
(12) Patent Application Publication
(10) Pub. No.: US 2025/0331082 A1
(43) Pub. Date: Oct. 23, 2025

(54) Voice-Activated Warning and Ornamental Light Device

(71) Applicants: Emile Seraphin, North Tonawanda, NY (US); Suhib Salim, Wayne, NJ (US)

(72) Inventors: Emile Seraphin, North Tonawanda, NY (US); Suhib Salim, Wayne, NJ (US)

(21) Appl. No.: 19/257,675

(22) Filed: Jul. 2, 2025

(51) Int. Cl. H05B 47/12; G10L 25/78; H05B 45/20; H05B 47/155

(52) U.S. Cl. CPC H05B 47/12; G10L 25/78; H05B 45/20; H05B 47/155; G10L 2025/783

(57) ABSTRACT

A voice-activated warning and ornamental lighting device is disclosed for use with personal computing and gaming systems. The device, referred to as a loudstick, comprises a control module configured to receive and process real-time digital audio signals from a user-selected microphone via a USB Type-C connection. The device monitors voice amplitude and activates a visual warning signal when the voice exceeds a configurable threshold. The warning is displayed using an LED array that transitions from green to red, with selectable flash modes available. A digital control interface within companion software allows the user to adjust the voice threshold level. When not operating in voice monitoring mode, the LED array provides ornamental lighting through a series of programmable RGB lighting patterns. The device integrates real-time audio monitoring with configurable visual feedback and aesthetic lighting in a compact form suitable for desktops or gaming setups.

### FIELD OF THE INVENTION

The present invention relates to voice monitoring devices and, more specifically, to a real-time visual alert and decorative lighting system for personal gaming setups that utilizes a user-selected microphone to provide customizable, aesthetic, and practical voice volume feedback. The audio-visual feedback systems use an adaptive hardware-software platform that provides real-time vocal modulation guidance i.e. real time warnings when vocal volume exceeds user-defined threshold, while also serving as an ornamental light when the volume is as per the preset threshold. The system serves dual functionality i.e. both as a warning system and a customizable ambient lighting system for gaming environments. It is particularly useful for gamers, streamers, and remote workers to control vocal output without disrupting their workflow.

### BACKGROUND

In the modern digital landscape, voice-based interaction has become integral to online gaming, streaming, and remote collaboration. As gamers and streamers frequently communicate in multiplayer environments or while broadcasting live, these users often become unaware of how loudly they are speaking, which can cause disturbances to others in the vicinity. With the growing popularity of online gaming and content streaming, there is an increasing need for devices that help users manage their speaking volume during high-intensity gaming sessions. Excessive vocal noise can be disruptive in shared spaces, and users often remain unaware of their volume levels. Furthermore, gaming enthusiasts often seek unique, aesthetically appealing components for their setups.

To address this, various software-based voice meters such as OBS (Open Broadcaster Software) and Voicemeeter have been developed to visually display audio levels. However, these tools suffer from critical limitations: they provide on-screen-only feedback, which lacks physical presence. The user must shift their visual focus to a secondary monitor or application window to notice voice spikes, which is impractical during gameplay or live broadcasts. Moreover, these software tools offer no tactile or peripheral visual indicators that could alert the user in real time without disrupting the core activity.

Standalone noise-monitoring devices do exist-typically used in classrooms or industrial settings—but they are often not optimized for personal computing environments, lacking integration with PC or console systems. These devices usually rely on built-in or dedicated microphones rather than leveraging the user's preferred microphone setup (e.g., high-quality USB mics or gaming headsets). As such, they fail to reflect the actual transmitted voice level that others hear. Thus, the current noise-monitoring solutions are either software-based or dependent on internal microphones, often lacking customization, aesthetic appeal, or the immediacy required for gaming contexts.

Additionally, while USB-connected LED accessories exist on the market, their primary function is decorative or static in nature; they do not respond dynamically to voice input or audio thresholds. They are incapable of serving as feedback mechanisms for voice modulation. Crucially, none of the existing hardware-software platform offers an integrated ornamental lighting system that transitions from aesthetic mode to warning mode based on real-time audio behaviour. There remains a notable absence of dedicated hardware-software based platform, customizable LED solutions designed specifically for voice volume feedback in personal gaming setups. This gap results in missed opportunities for providing non-intrusive, low-latency feedback to users-especially in high-focus scenarios like gaming or live streaming-without affecting system performance or introducing delays in audio transmission.

Accordingly, there exists a need for a hardware-software based, real-time, user-configurable device that provides both voice volume alerts and aesthetic enhancement. The present invention, referred to as the Loud Stick, addresses the aforesaid deficiencies by providing a dual-function device that:
Offers real-time, low-latency warning feedback (<50 ms) in the form of customizable LED alerts when voice volume exceeds a preset threshold.
Uses the user's selected microphone rather than a separate internal mic.
Integrates gaming-themed aesthetic lighting when not in active warning mode.
Enables profile-based settings for different genres or applications (e.g., FPS, streaming, co-op).
Functions as a standalone, discreet hardware peripheral requiring no user distraction or screen interaction during operation.

This invention therefore provides a practical, real-time, and visually effective solution to a problem that is otherwise poorly addressed by existing audio monitoring tools or decorative accessories. This invention bridges the gap between audio processing technologies and human-computer interaction by creating a closed-loop feedback system for vocal control in digital environments.

### SUMMARY

The present invention relates to a voice-activated warning and ornamental lighting device designed for use with personal computing and gaming devices. Referred to herein as the “Loud Stick,” the invention provides real-time visual feedback in response to voice volume, enabling users to self-modulate their speech levels in dynamic environments such as online gaming, streaming, or shared living spaces.

The present invention, termed the Loud Stick, is a hardware-software integrated system that provides real-time, voice-activated visual alerts and ornamental lighting for gaming and streaming environments. It is particularly suited for users who require non-intrusive, peripheral voice modulation feedback without diverting attention from high-focus activities such as online gaming, streaming, or remote collaboration.

The invention incorporates a compact housing interfaced with a personal computer or gaming console via a USB Type-C connection, which serves the dual purpose of power supply and bi-directional data communication. This interface allows seamless integration with existing computing systems while maintaining low-latency performance.

Crucially, the Loud Stick is designed to operate using the user's selected microphone-typically a USB headset, condenser mic, or gaming microphone-rather than a built-in or internal microphone. This ensures the system reflects the actual transmitted voice level heard by teammates or an audience, increasing the precision and relevance of the feedback provided.

At the heart of the device lies an RGB LED array, which is embedded in a vertically oriented translucent pillar (light diffuser) mounted on a structured base housing. The RGB LEDs operate in two primary modes:
Warning Mode: When the real-time voice input exceeds a configurable decibel threshold (user-definable between approximately 30 and 120 dB), the LED array enters an alert state. In this mode, the system can be configured to either flash red only or alternate between red and blue, depending on the user's selected feedback profile.
Ambient Mode: When the voice input is below the threshold, the LEDs transition to customizable aesthetic lighting patterns, enhancing the visual ambiance of the user's setup with effects such as Fire Mode, Berry Mode, or Rainbow Cycle. Up to 16.8 million color combinations are supported.

The control module inside the base housing contains a real-time audio processing unit that continuously monitors microphone input with a latency of less than 50 milliseconds. Audio data is analyzed and compared against the user-defined threshold to determine whether a transition to warning mode is warranted.

Users interact with the system via an intuitive digital control interface and optional companion software. The interface includes:
A slider for adjusting the volume threshold.
Two toggle buttons for selecting between red-only or red-blue flashing alert behaviors.

The companion software provides deeper customization, allowing users to:
Calibrate the sensitivity threshold across a configurable decibel range.
Define lighting patterns and intensity levels based on personal preference or streaming themes.
Save and switch between profiles, optimizing lighting and alert behavior based on activity (e.g., FPS games vs. conference calls).

The invention therefore offers a dual-purpose solution that combines real-time audio alerting with visually appealing, customizable lighting. It satisfies an unmet demand in the gaming and streaming communities by providing instantaneous peripheral feedback without screen distractions, added latency, or reliance on non-user microphones.

Moreover, by leveraging a modular design and providing configuration via software controls, the Loud Stick enables flexible deployment in diverse environments such as esports training rooms, personal gaming setups, live-stream studios, or remote workstations.

### BRIEF DESCRIPTION OF THE DRAWINGS

The accompanying drawings, which are incorporated in and constitute a part of this specification, illustrate various embodiments of the present invention and together with the description serve to explain the principles of the invention.

FIG. 1 is a of perspective view of one embodiment of the Loud Stick device, showing the overall external structure including the translucent light diffuser (pillar) (101), the base housing (102), and the USB Type-C interface (103).

FIG. 2 is an exploded view of the Loud Stick device, illustrating internal components such as the LED mounting structure (201), the metal-core printed circuit board (MCPCB) carrying RGB LEDs (202), and the control module housed within the base.

FIG. 3 is a schematic block diagram of the system, including the microphone input path (301), control module (302), the voice threshold monitoring module (303), RGB LED control unit (304), and power/data interface (305).

FIG. 4 is a functional flowchart depicting the operational logic of the device, from microphone input detection to real-time threshold comparison and LED behavior control in warning and ambient modes.

### DETAILED DESCRIPTION

The following description provides a detailed illustration of the present invention. The invention relates to a voice-activated lighting and warning device designed to provide real-time visual feedback in response to the intensity of a user's voice. The invention, herein referred to as the Loud Stick, is particularly suited for gaming environments, streaming setups, shared living arrangements, and other scenarios where vocal modulation and ornamental feedback are desirable. While specific embodiments and examples are provided, the scope of the invention is not limited to these particular configurations.

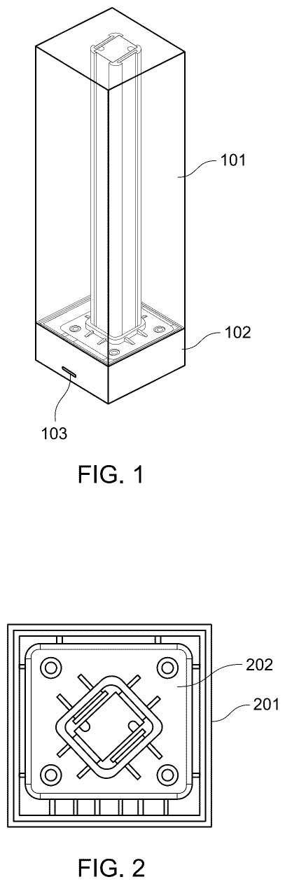

Referring now to FIG. 1 and FIG. 2, the Loud Stick device comprises three main physical components:
A Translucent Light Diffuser (Pillar) [101], which is vertically mounted and fabricated from frosted acrylic or light-diffusing resin. This element ensures that RGB LED emissions are evenly distributed, avoiding visual hotspots.
A Base Housing [102], which is a square or rectangular enclosure made of durable, opaque material such as aluminum or polycarbonate. It contains the internal circuitry, power delivery system, and USB interface.
An LED Mounting Structure [201], which includes a central mounting column designed to support a metal-core PCB that hosts the RGB LEDs. The structure incorporates reflective surfaces for enhancing luminous output efficiency.

The housing is interfaced with a host system, such as a personal computer or gaming console, via a USB Type-C connector [103]. This single interface serves both power delivery and data communication purposes, eliminating the need for separate audio input cables.

The device uses the user-selected microphone (e.g., USB microphone or headset) already in use for voice communication. This ensures the vocal input used for monitoring reflects the actual transmitted audio, rather than environmental noise.

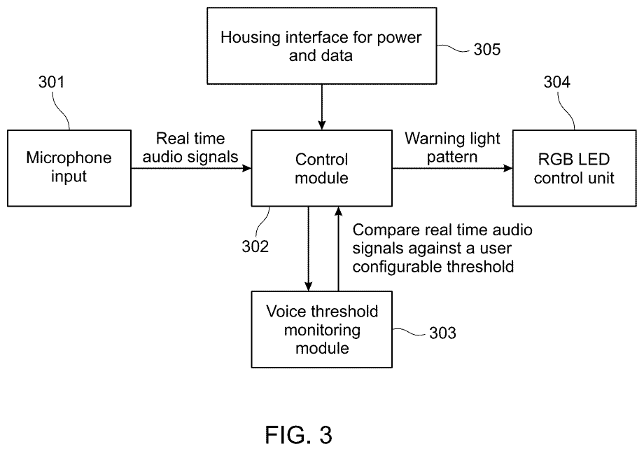

Referring to FIG. 3, a schematic block diagram illustrates the internal architecture of the Loud Stick. The system includes:
A Microphone Input Interface (301), which digitally accesses audio data from the host system's selected microphone.
A Control Module (302) which receives input signals from the microphone input interface and is also coupled to a voice threshold monitoring module. Upon receiving a threshold breach signal, the control module triggers a corresponding light response.
A Voice Threshold Monitoring Module (303), which analyzes the real-time audio stream and compares its decibel level to a user-configured threshold, adjustable within a range of approximately 30-120 dB.
An RGB LED Array Driver (304), which is governed by the control module and dynamically actuates the LEDs mounted on the LED PCB.
A User Configuration Interface (305), supported through companion software and onboard controls, that allows adjustment of thresholds, lighting modes, and profile presets.

The control module capable of real-time digital audio processing. The voice signal received through the host system is continuously monitored to determine whether it exceeds a user-defined threshold. This threshold is adjustable through a user configuration interface provided via companion software. The user configuration interface allows users to set the voice sensitivity threshold within a configurable range (e.g., 30-120 dB). A dynamic bar next to the slider displays the live amplitude of the voice input as a progressing green-to-red visual spectrum, indicating both the real-time level and the selected threshold line.

When the detected voice input surpasses the threshold, the Loud Stick immediately activates a warning mode. In the default setting, all 14 RGB LEDs illuminate in a bright red flash for approximately three seconds, visually alerting the user. Two buttons situated above the slider allow users to select alternate alert behaviors. Pressing the left button configures the alert to flash only red LEDs upon threshold breach. Pressing the right button configures the alert to flash alternating red and blue LEDs in a “police-light” fashion, also for three seconds. This configuration offers a customizable feedback mechanism without introducing auditory interruptions or latency into the user's microphone signal.

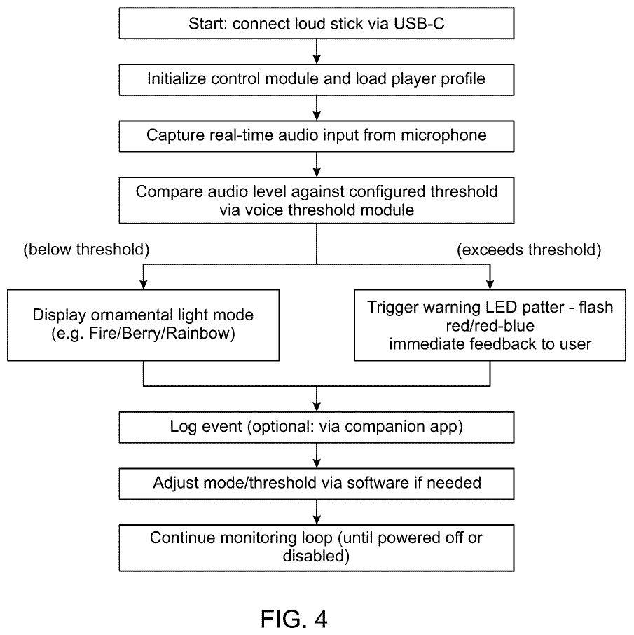

Turning to FIG. 4, a functional flow diagram illustrates the operational logic of the Loud Stick in a real-world training environment. When activated, the device enters a Monitoring Mode:
The audio signal is acquired from the user's microphone.
The signal is then analyzed by the threshold monitoring logic.
If the signal exceeds the preset threshold, a warning signal is generated.
The control module triggers the RGB LEDs to flash red or in an alternating red-blue pattern depending on user input via hardware buttons or software profile.
If the signal does not exceed the threshold, the device remains in ambient lighting mode, such as Fire, Berry, or Rainbow, enhancing visual appeal without user distraction.

The companion software provides an intuitive GUI with slider controls for adjusting the decibel threshold, toggles for selecting alert modes, and a color palette for customizing ornamental effects. It also supports profile-based customization tailored to different game genres (e.g., FPS vs. RPG).

This modularity allows the Loud Stick to serve dual functions: as a real-time vocal modulation tool and a gaming-themed lighting accessory. Importantly, the system operates without introducing audio latency or requiring visual attention, making it ideal for uninterrupted gameplay or live content creation.

The LEDs themselves-designated as LEDs 1 through 14—are addressable and capable of displaying complex lighting animations, which enable multiple operational modes. In Voice Monitoring Mode, the LEDs act as a progressive voice meter. As the user speaks, LEDs light up sequentially with increasing brightness in green, visually representing voice intensity. Upon threshold breach, the configured red or red-blue flashing alert is activated.

In Fire Mode, the LEDs simulate a flame effect using a bottom-to-top color gradient. LEDs 1 through 4 are set to red, LEDs 5 through 9 to orange, and LEDs 10 through 14 to yellow. The animation simulates rising heat by cycling the brightness in a smooth, upward “breathe” motion, maintaining all LEDs on at varying intensities to emulate the dynamic behavior of live flames.

In Berry Mode, the LEDs are grouped into three segments: purple (LEDs 1-4), pink (LEDs 5-9), and blue (LEDs 10-14). This mode alternates between two distinct effects—Glow and Twinkle. During the Glow phase, each group of LEDs gradually brightens in sequence from dim to full intensity, creating a flowing visual transition from purple to pink to blue. During the Twinkle phase, the LEDs within each segment flicker in a randomized pattern without turning off completely, simulating the sparkle of light reflections. The system alternates between Glow and Twinkle every seven seconds.

The Lightning/Thunder Mode offers a dramatic aesthetic by alternating between white and yellow color schemes. Each breathing cycle involves one color fading in and out before switching to the other, producing a pulsating effect reminiscent of lightning flashes during a storm. The transition is smooth and continuous, maintaining a hypnotic storm-like ambiance.

In Rainbow Mode, the device displays a full-spectrum color wave flowing across all 14 LEDs. This mode cycles through the entire RGB spectrum in a smooth, continuous motion, creating a vibrant and animated appearance ideal for background lighting in a gaming or streaming environment.

The Loud Stick offers distinct advantages over conventional solutions by combining ornamental lighting with practical voice-level monitoring in a single compact device. It delivers visual feedback with latency below 50 milliseconds and operates non-intrusively, introducing no audible delays or interference. Unlike conventional software meters and classroom noise monitors, it uses the user's actual microphone and is tailored for real-time, gaming-specific applications. In addition to aesthetic lighting, the device introduces the concept of a customizable, and discrete voice feedback mechanism-fulfilling a niche left unaddressed by current consumer electronics.

In one practical embodiment (as described with reference to FIGS. 3 and 4), the Loud Stick is deployed in a professional esports training facility where each player has an individual device synchronized via the companion app. Coaches can set uniform thresholds across all units, ensuring consistent vocal discipline without manual intervention during high-focus sessions. Since, within an Esports training facility, multiple professional or semi-professional gamers train together in a shared environment, thus these facilities typically involve high-intensity team communication, coaching sessions, and extended periods of competitive gameplay, during which players often raise their voices due to adrenaline or focus. The Loud Stick, connected to each player's gaming rig via a USB Type-C interface, continuously monitors individual vocal output through the active microphone already in use by each player (e.g., a gaming headset or USB mic). During training sessions, each device operates in voice monitoring module, providing immediate, localized feedback to the player if their vocal output exceeds a preset threshold. For instance, if a player becomes excessively loud, their device will flash red or alternate red-blue (depending on the selected button mode), alerting them to reduce their voice level without disrupting gameplay or communication. Team coaches may set uniform threshold calibration levels across all Loud Sticks via the companion software, ensuring consistent vocal behavior across the team. The adjustable nature of the threshold (e.g., 30-120 dB range) allows sensitivity to be fine-tuned depending on the environment-whether the team is in a soundproof room or open-plan facility. In between matches or during downtime, the Loud Stick can operate in ambient aesthetic modes such as Fire Mode, Berry Mode, or Rainbow Mode. This enhances the visual appeal of the training space and aligns with the vibrant branding commonly associated with esports teams. The ornamental lighting also contributes to a more immersive atmosphere during streaming or recording of scrimmage sessions. Furthermore, as esports teams often practice across different game genres (e.g., fast-paced first-person shooters versus more strategy-oriented RPGs), the invention allows players to load custom lighting and sensitivity profiles matched to game type or training intensity. For example, a more lenient threshold may be appropriate for relaxed practice matches, while a stricter one is useful during tournament simulations. This embodiment enables esports organizations to promote discipline in communication, reduce vocal strain, and maintain professional conduct during practice, all while preserving an appealing and performance-driven aesthetic. The Loud Stick's immediate visual feedback also reduces reliance on coaches to moderate voice behavior, allowing them to focus on strategic instruction and gameplay mechanics.

In another embodiment, the present invention is utilized within gaming cafes and lounges, where multiple users engage in recreational or competitive gameplay in a semi-public setting. Such environments are often characterized by shared physical spaces, minimal acoustic separation, and high background noise levels. As users become immersed in gameplay—particularly in competitive or cooperative multiplayer scenarios—they may unintentionally raise their voices, leading to disturbances among patrons or interference with adjacent gameplay stations. The Loud Stick, when installed at each gaming station and connected via USB Type-C to the respective gaming device or PC, functions as an individualized voice-monitoring and alert system. By leveraging the microphone already selected by the user—typically integrated with gaming headsets—the Loud Stick continuously monitors voice levels in real time. When a user exceeds a configurable voice threshold, the device responds by activating a flashing red warning signal, or an alternating red-blue police-style alert, depending on the selected mode via the device's user configuration interface supported by companion software. This immediate visual cue provides real-time feedback, encouraging self-moderation without requiring intervention from staff or affecting the broader cafe environment. The configurable threshold—adjustable via companion software or on-screen UI—allows cafe operators to standardize acceptable vocal intensity levels across all stations. This helps maintain a more controlled and pleasant auditory environment for all users, including casual players, spectators, and staff. Furthermore, this system discourages disruptive behavior without resorting to intrusive monitoring or administrative enforcement, fostering a more self-regulated and respectful user experience. During non-peak hours or in non-competitive use, the Loud Stick can function in its ornamental lighting capacity, enhancing the visual ambiance of the gaming lounge. Modes such as Fire Mode, Berry Mode, Lightning Mode, or Rainbow Mode allow cafe operators to align lighting effects with the cafe's theme, event promotions, or branding aesthetics. For instance, the Berry Mode with soft twinkling LEDs may be activated during casual gaming nights, while Fire Mode or Rainbow Mode may be utilized during tournaments or community events to elevate excitement. Moreover, the non-intrusive operation of the Loud Stick ensures that no additional latency or audio processing delay is introduced into the user's system, preserving the integrity of gameplay—an essential consideration for premium gaming cafes catering to serious players. By offering both functional voice control and aesthetic customization, the Loud Stick enhances both user experience and environmental harmony within gaming cafes and lounges. Future enhancements may include a wireless version, app-based configuration, group mic support, bluetooth support for team environments, modular extensions, and haptic feedback integration. However, the present embodiment provides a powerful, low-latency, and user-configurable solution for vocal self-awareness and immersive lighting effects in personal computing environments.

In yet another embodiment, the Loud Stick is implemented within home streaming studios or environments, where content creators engage in live broadcasting, voiceover recording, or gameplay streaming to online platforms. In such setups, streamers often operate in confined spaces with limited acoustic insulation and may become unintentionally loud during moments of heightened excitement, audience interaction, or intense gameplay. This excessive vocal output can result in audio clipping, degraded stream quality, or disturbances to cohabitants in shared living environments. The Loud Stick offers a dedicated, real-time voice monitoring and feedback solution to address these challenges. Connected to the streamer's computer via a USB Type-C interface, the Loud Stick interfaces with the user-selected microphone—be it a USB condenser mic, XLR mic via interface, or integrated headset—and actively monitors the voice amplitude. When the user's vocal output exceeds a preconfigured threshold, the device triggers a visual alert, either in the form of a full red LED flash or an alternating red and blue sequence, depending on the configured mode. These modes are selectable via tactile interface buttons through the associated companion software, which also allows fine control of the decibel threshold, animation duration, and LED behavior. For streamers, this visual cue is highly advantageous, as it provides non-intrusive, on-camera feedback without the need for additional software-based audio meters that require monitoring a secondary screen. The warning LED behavior is easily noticeable in the streamer's peripheral vision or reflected in camera previews, allowing for on-the-fly voice modulation without interrupting the stream. This helps preserve audio quality, prevents overdriving microphones, and maintains a consistent auditory experience for viewers. Outside of active voice monitoring, the Loud Stick enhances the visual aesthetics of the streaming space by operating in ornamental lighting modes. The user may select from Fire Mode, Berry Mode, Lightning Mode, or Rainbow Mode to match the ambiance or branding of their channel. For example, a streamer may activate Rainbow Mode during donation milestones or subscriber celebrations, while Fire Mode may be linked to high-action gameplay sequences. These lighting patterns are designed to be broadcast-friendly, offering dynamic but non-distracting effects that integrate naturally into on-screen visuals.

Furthermore, due to its compact form factor, low-latency operation, and customizable profiles, the Loud Stick becomes a versatile peripheral for streamers of various content types—including gaming, podcasts, ASMR, and educational streams. The device introduces no audio processing latency, ensuring compatibility with latency-sensitive recording and broadcasting workflows. Overall, in home streaming setups, the Loud Stick provides a unique combination of functionality and personalization, enabling streamers to maintain professional audio discipline while enriching their visual production with vibrant, customizable lighting—thereby elevating both the technical and creative quality of the streaming environment.

In an additional embodiment, the Loud Stick is employed in remote work setups, virtual classrooms, and smart home environments, where maintaining appropriate vocal levels and minimizing noise disruption is increasingly important. With the widespread adoption of video conferencing and virtual communication platforms in professional and educational settings, users frequently participate in meetings, lectures, and collaborative sessions from home or other shared spaces. These environments often lack professional-grade acoustic treatment, leading to unintended voice projection and disturbances. The Loud Stick addresses these challenges by providing real-time, physical feedback to users based on their vocal intensity. In a remote work scenario, an individual participating in a virtual meeting can use the Loud Stick to monitor their speaking volume. When the user's voice exceeds the configurable threshold—adjustable via the companion software—the device triggers a warning signal. Depending on the selected mode, this may involve a full red LED flash or an alternating red-blue sequence, both of which serve as instant visual reminders to lower one's voice, helping users maintain a professional and considerate communication style. In distance learning environments, particularly where children or students are participating in online classes from home, the Loud Stick acts as a behavioral aid. It provides a clear, visual indicator to students who may be speaking too loudly or disrupting the flow of instruction. Educators and parents benefit from a non-verbal, automated tool that reinforces classroom decorum and respectful communication without constant intervention. The user-friendly interface allows children to visually engage with their voice levels, encouraging self-regulation through gamified interaction with the LED feedback system.

Furthermore, the Loud Stick can be integrated into smart home ecosystems, either directly or via third-party applications and platforms. With potential support for smart assistants or IFTTT (If This Then That) protocols, the device may trigger other actions based on user volume—such as dimming lights, sending notifications, or logging noise events for parental monitoring or productivity analytics. The device's ornamental lighting modes—such as Fire Mode, Berry Mode, or Lightning Mode—can also be used to create a calming or stimulating environment during work or study hours, contributing to ambiance and mood regulation in the space.

Because of its compact design, minimal latency, and silent operation, the Loud Stick integrates seamlessly into desktop setups and learning stations without adding clutter or distractions. It does not process audio output or introduce delay into communication platforms, ensuring full compatibility with professional conferencing software, learning management systems, and smart home hubs.

Overall, in these secondary applications, the Loud Stick transforms into a multi-functional utility—simultaneously promoting vocal discipline, enhancing user engagement, and elevating the technological ambiance of the modern home, workspace, or classroom. This embodiment showcases the invention's adaptability across various user demographics and settings beyond gaming.

The invention thereby addresses a significant gap in the existing market, combining the functional benefits of noise-monitoring with the aesthetic appeal expected by gamers and streamers. The unique integration of real-time microphone input, threshold analysis, and dynamic lighting control through a compact, visually striking device is not known in prior art.

1. A voice-activated warning and ornamental lighting device, comprising:
a housing having an interface for power and data communication;
a control module configured to process real-time audio signals received from a user-selected microphone;
an array of red-green-blue light emitting diodes (RGB LEDs) positioned on the housing;
a voice threshold monitoring module configured to compare real time audio signals against a user-configurable threshold; and
wherein the RGB LED array is configured to display a visual warning pattern based on input received from the voice threshold monitoring module.

2. The device of claim 1, wherein the control module is positioned in the housing.

3. The device of claim 1, wherein the RGB LED array display dynamic visual feedback based on the input of voice threshold monitoring module, including:
a progression of green illumination corresponding to increasing voice intensity; and
activation of a red illumination when the audio signal exceeds the threshold.

4. The device of claim 1, wherein the control module is further configured to operate the LED array in one or more ornamental lighting modes independent of voice input, the modes comprising:
a simulating flame mode using red, orange, and yellow segments with increasing intensity;
a color alternating mode using purple, pink, and blue lighting with glow and twinkle effects, a lightning simulation mode with alternating white and yellow breathing patterns; and
a rainbow wave mode with full-spectrum animated transitions.

5. The device of claim 1, wherein the control module and the voice threshold monitoring module is connected to a companion software, the companion software is configured for:
calibrate the voice volume threshold;
customize the lighting modes and colors; and
create and store lighting profiles tailored to user preferences or gaming genres.

6. The device of claim 1, wherein the housing is connected to a computing device via a USB Type-C interface for power delivery and data communication.

7. The device of claim 1, wherein the control module is configured to initiate all lighting feedback under 50 milliseconds of detecting an audio input above the threshold.

8. The device of claim 1, wherein the housing further comprises a visual user interface comprising:
a real-time 2D LED model display; and
a visual bar indictor that transitions from green to red to represent the current voice level relative to the threshold.

9. The device of claim 1, wherein the RGB LED array comprises at least fourteen independently controllable LED segments for generating both warning and ornamental lighting patterns.
